(19) United States
(12) Patent Application Publication
(10) Pub. No.: US 2026/0060864 A1
(43) Pub. Date: Mar. 5, 2026

(54) PRESSURE CONTROLLED MATTRESS FOR AN INFANT CARE DEVICE

(71) Applicant: GE Precision Healthcare LLC, Waukesha, WI (US)

(72) Inventors: Steven M. Falk, Baltimore, MD (US); Rajendra Naik, Bangalore (IN); Benoy Abraham, Bangalore (IN); Shrihari Viswanath, Bangalore (IN)

(21) Appl. No.: 19/307,437

(22) Filed: Aug. 22, 2025

(30) Foreign Application Priority Data
Aug. 30, 2024 (IN) 202441065520

(51) Int. Cl. A61G 11/00

(52) U.S. Cl. CPC A61G 11/001

(57) ABSTRACT

An infant care device for use with a baby includes a mattress configured to support the baby within the infant care device, air pockets forming a top surface of the mattress, and pressure sensors disposed within each of the air pockets, the pressure sensors being configured to sense a location of the baby on the mattress. Air pressures of the plurality of air pockets are individually adjusted based on the sensed location of the baby.

### CROSS-REFERENCE TO RELATED APPLICATIONS

This application is based on and claims priority to India application No. 202441065520, filed on Aug. 30, 2024, the entire contents of which is herein incorporated by reference.

### BACKGROUND

The present disclosure generally relates to neonatal care systems, and more specifically to neonatal care systems having a system and method to detect the location of a baby and characteristics of the baby within an infant care device, such as an incubator or infant warmer.

Some neonates are not physiologically well enough developed to be able to survive without special medical attention. A frequently used medical aid for such infants is the incubator. The primary objective of the incubator is to provide an environment which will maintain the neonate at a minimum metabolic state thereby permitting as rapid physiological development as possible. Neonatal incubators create a microenvironment that is thermally neutral where a neonate can develop. These incubators typically include a humidifier and a heater and associated control system that controls the humidity and temperature in the neonatal microenvironment. The humidifier comprises a device that evaporates an evaporant, such as distilled water, to increase relative humidity of air within the neonatal microenvironment. The humidifier is typically controllable such that the amount of water, or water vapor, added to the microenvironment is adjustable in order to control the humidity to a desired value. The heater may be, for example, an air heater controllable to maintain the microenvironment area to a certain temperature. Radiant heat infant warmers may be used instead of incubators for some neonates where less environmental control is required. In still other embodiments, hybrid incubator/radiant warming systems may be utilized, various embodiments of which are well known in the art.

Neonatal incubators typically define an enclosure that includes multiple portholes on the sides of the incubator that allow a caregiver to contact and manipulate the baby contained within the incubator. The size and location of the portholes are designed to provide the required access to the baby while still creating a regulated environment within the enclosure. The portholes thus create openings within the enclosure which are often large enough to allow a small baby to pass therethrough. In the case of an infant warmer, the warmer includes sidewalls that can be raised and lowered by the caregiver and include latches to hold the sidewalls in the raised positions.

During the neonate's time within the incubator, the neonate may require repositioning by the caregiver to accommodate for procedures, treatments, feedings, and the like. The caregiver additionally measures characteristics of the neonate, such as weight of the neonate. Each time the caregiver interacts with the neonate, the neonate is exposed to the environment external of the incubator. This exposure can introduce risks such as temperature fluctuations, potential infections, and other environmental hazards. The need exists for a system that can automatically adjust to a neonate's movements, provide accurate assessments, and maintain the neonate's state with minimal contact from the caregiver. Such a system would enhance safety and care quality of neonates within neonatal incubators.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In some aspects, the techniques described herein relate to an infant care device for use with a baby, including: a mattress configured to support the baby within the infant care device; air pockets forming a top surface of the mattress; and pressure sensors disposed within each of the air pockets, the pressure sensors being configured to sense a location of the baby on the mattress; wherein air pressures of the plurality of air pockets are individually adjusted based on the sensed location of the baby.

In some aspects, the techniques described herein relate to an infant care device for use with a baby, including: a mattress configured to support the baby within the infant care device; air pockets forming a top surface of the mattress; and a control unit including a stored inflation pattern for individually adjusting air pressures of the air pockets; wherein inflating the air pockets based on the inflation pattern moves the baby from a first position to a second position.

In some aspects, the techniques described herein relate to a method of preventing a baby from falling from an infant care device including a mattress, including: positioning pressure sensors within air pockets on the mattress; determining the baby is moving toward an edge of the mattress based on information received from the pressure sensors; and individually inflating the air pockets to move the baby away from the edge of the mattress.

Various other features, objects, and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a perspective view of an exemplary neonatal incubator system in accordance with an exemplary embodiment of the present disclosure;

FIG. 2 depicts another embodiment of a neonatal incubator system according to another embodiment of the present disclosure;

FIG. 3 depicts one exemplary embodiment of a mattress, mattress tray and multiple load cells used with an infant care device;

FIG. 4 is a schematic illustration of the mattress and air pockets in accordance with an embodiment of the present disclosure;

FIG. 5 is a schematic illustration of the mattress and air pockets in accordance with an embodiment of the present disclosure;

FIG. 6 depicts another exemplary embodiment of the mattress and air pockets in accordance with an embodiment of the present disclosure;

FIG. 7 illustrates an exemplary embodiment of the mattress, air pockets, and air control unit in accordance with an embodiment of the present disclosure;

FIG. 8 illustrates an exemplary embodiment of a control system according to an embodiment of the present disclosure;

FIG. 9 depicts one exemplary embodiment of a method for sensing baby movement and preventing further movement of the baby;

FIG. 10 depicts another exemplary embodiment of a method for sensing baby movement and preventing further movement of the baby;

FIG. 11 depicts one exemplary embodiment of a method for determining whether the baby is breathing; and

FIG. 12 depicts one exemplary embodiment of a method for determining whether chest compressions are being properly performed on the baby.

### DETAILED DESCRIPTION

The inventors have recognized a problem with current incubator systems for neonatal care, which is that the neonatal incubators have portholes or openings on their sidewalls so that a caregiver can access the baby lying on the mattress within the incubator. The mattress can be tilted to give a head-low or head-up position. When babies are positioned within the incubator, the babies can move in all of the directions on the mattress and could potentially fall out of the portholes on the sides of the incubator, possibly resulting in life-threatening injuries. Further, a caregiver may be in charge of monitoring multiple babies in multiple incubators, which decreases the amount of individual attention the caregiver can give to each of the babies. In some cases, the caregiver may be occupied with moving one of the babies or performing a procedure and thus is not providing full attention to the other babies under her/his care. This can be extremely challenging in stressful environments, like a neonatal intensive care unit (NICU), or where the patient-to-caregiver ratio is high.

In the case of an infant warmer, the infant warmer has side walls located at each of the sides and each of the ends of the mattress that can be lowered to provide better access to the baby supported on the mattress of the infant warmer. The mattress can be tilted to give a head-low or head-up position when needed. If the side walls are not properly latched in the upright position or if one of the side walls is left in the lowered position, a risk exists that a baby could fall from the infant warmer.

The inventors have also recognized the need for a system that reduces the number of interactions required between a caregiver and a baby. Specifically, the baby may require repositioning by the caregiver to accommodate for procedures, treatments, feedings, and the like. The caregiver additionally measures characteristics of the baby, such as weight of the baby. Each time the caregiver interacts with the baby, the baby is exposed to the environment external of the incubator. This exposure can introduce risks such as temperature fluctuations, potential infections, and other environmental hazards.

Accordingly, the inventors have developed a multi pocket pressure-controlled mattress that measures a weight of a baby and a location and/or position of a baby via pressure sensors. The pockets of the mattress can be height adjusted locally using pressure pumps in order to change the location of the baby to prevent the baby from falling off of the mattress. The mattress may additionally position the baby for procedures, treatments, feeding, and the like. Measuring the pressure sensors may additionally be used to measure characteristics of the baby, such as the weight of the baby, the breathing pattern of the baby, and other characteristics that will be explained in greater detail below.

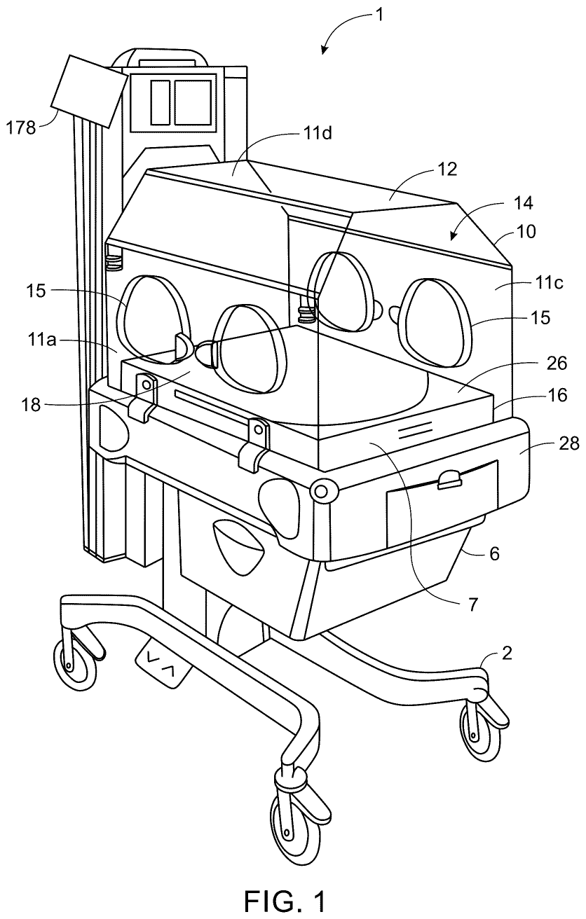

FIG. 1 depicts one embodiment of an infant care device 1 having an enclosure 10. As will be understood by a person having ordinary skill in the art, the disclosed system and method may be implemented on various types of infant care devices, including incubators, incubator/warmer systems and radiant warmer systems having enclosures with side panels to create a controlled environment enclosable to secure the baby within an area on the platform 16. The term infant care device is meant to encompass each of these different types of devices, along with other similar devices used during the care of an infant.

The depicted infant care device 1 shown in FIG. 1 is an incubator system that includes a base 2 that supports a platform 16 configured for receiving and supporting a neonate baby. In the depicted embodiment, the base 2 includes a horizontal section comprising a pair of u-shaped horizontal members joined together and providing support for a vertical base member extending upward toward the platform 16. The base 2 may include wheels to provide for ready movement of the infant care device 1. A platform 16 is supported on the vertical base member, which may be a standard platform for supporting a baby, which includes a mattress tray and mattress, as will be discussed below.

The infant care device 1 includes the enclosure 10 defining a chamber 14 creating a microenvironment for housing a baby. The enclosure 10 may be, for example, a transparent housing extending above the platform 16. The enclosure 10 creates and defines a chamber 14 providing a microenvironment, which is an area around the baby where temperature, humidity, and other environmental factors can be controlled.

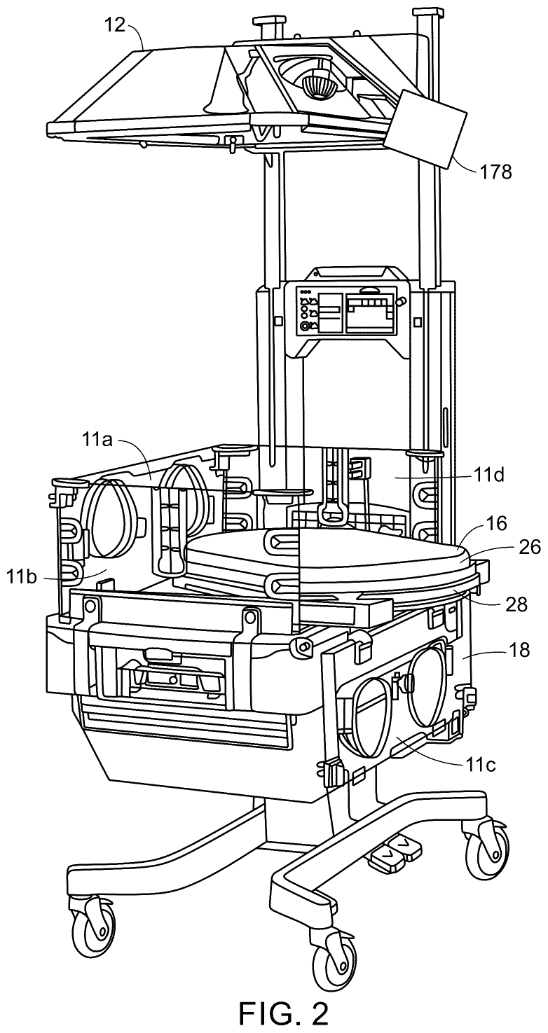

The enclosure 10 includes multiple side walls 11a-11d and a top portion 12. For example, the side walls 11a-11d and/or the top portion 12 of the enclosure 10 may be made of a transparent plastic material, as is standard in the relevant art. In various embodiments, the top portion 12 may be integrated with the side walls 11a-11d. In other embodiments, the top portion 12 may be separable from the side walls 11a-11d of the enclosure 10, as shown in FIG. 2. In the examples, the enclosure 10 includes a plurality of portholes 15 through which a caregiver may access the baby within the chamber 14. The infant care device 1 may further include a heater 7 used to control the temperature within the microenvironment of the chamber 14. For example, the chamber heater 7 may be a radiant heating or warming device that heats the air within the chamber 14 to a predefined temperature or within a predefined temperature range. In another embodiment, the heater 7 may comprise a convective or conductive heating device or any other type of controllable heating or warming device. The infant care device 1 may further include a humidifier system 6 controllable to adjust the relative humidity within with the chamber 14. For example, the humidifier may include a device that evaporates water, such as distilled water, to increase the relative humidity of air within the chamber 14.

The enclosure 10 includes one or more movable side panels 18 on a side wall 11a-11d of the enclosure 10. The movable side panel 18 is openable to place a baby on the platform 16 enclosable to secure the baby within the chamber 14. The movable side panel may be only part of a side wall 11a-11d of the enclosure 10, or may comprise the entirety of the side wall 11a, 11c as shown in the depicted embodiments. Although an incubator is shown in FIG. 1, an infant warmer would include similar side walls that can be raised and lowered as desired.

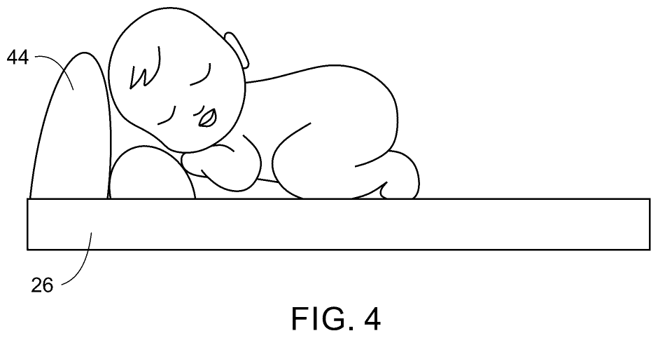

In FIG. 1, the movable side panel 18 is shown in a fully-closed position. FIG. 2 shows the movable side panel 18 in a fully open position. In certain embodiments exemplified at FIG. 2, the platform 16 may be configured to slide and/or rotate outward when the movable side panel 18 is open to enable easier access to a baby and/or to enable easy placement of the baby on the platform 16. The support platform 16 includes a mattress 26 resting upon a mattress tray 28. Although the mattress 26 shown in FIG. 4 is sized slightly smaller than the mattress tray 28, it should be understood that the mattress 26 could have the same size as the mattress tray 28. As can be understood in the views in FIGS. 1 and 2, the support platform 16, including both the mattress 26 and the mattress tray 28 are sized to be received within the enclosure 10 of the infant care device 1.

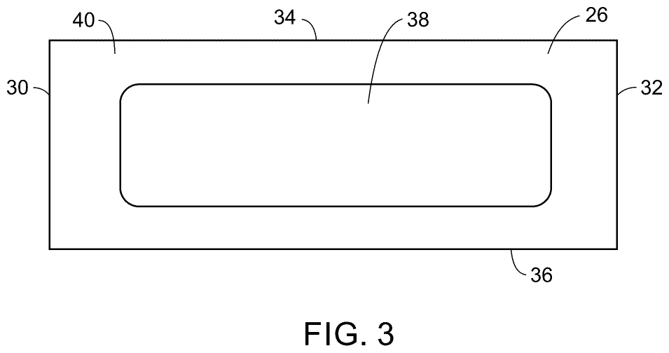

In the top view of the mattress 26 and mattress tray 28 shown in FIG. 3, the combination of the mattress 26 and mattress tray 28 define an outer perimeter defined by a first end 30, a second end 32, a first side 34 and a second side 36. The pair of ends and sides of the mattress 26 and mattress tray 28 define a support surface for a baby when the baby is positioned within the enclosure of the infant care device 1. In accordance with the present disclosure, a safe baby zone 38 is defined near the center of the mattress 26 while a potential fall zone 40 surrounds the safe baby zone 38.

The potential fall zone 40 is defined as the area of the mattress 26 between the safe baby zone 38 and the outer perimeter of the mattress 26 defined by the first and second side edges 34, 36 and the first and second ends 30, 32. As can be understood with reference to FIG. 1, when the center of gravity of the baby is located within the potential fall zone 40, the baby is located near one of the two ends or the side walls 11A, 11C and thus near the portholes 15. Depending upon the size of the baby, the baby may be able to pass through one of the portholes 15 and potentially fall from the elevated support platform 16. When the baby is located within the safe baby zone 38 shown in FIG. 3, the baby is located a sufficient distance away from the side walls and thus the portholes 15. In the case of an infant warmer, the baby may be able to fall from one of the side edges or one of the ends if one of the side walls give way or are not properly latched. Thus, when the center of gravity of the baby is within the safe baby zone 38, there is little to no risk that the baby may fall from the infant care device 1. However, when the center of gravity of the baby enters into the potential fall zone 40, the risk of the baby falling from the infant care device 1 is elevated.

With continued reference to FIG. 4, the mattress 26 includes a plurality of air pockets 44. The air pockets 44 are configured to support the baby when the baby is on the mattress 26. The air pockets 44 are individually inflatable and deflatable. Inflating or deflating the air pockets 44 changes a height of the air pocket 44, thereby changing a position of the portion of the baby supported by the air pocket 44. In other words, the baby may be repositioned by individually adjusting the heights of each of the air pockets 44. In some embodiments, the air pockets 44 span an entirety of a top surface of the mattress 26. In other words, the air pockets 44 together define the top surface of the mattress 26. In other embodiments, the air pockets 44 may solely partially span the top surface of the mattress 26. For example, the air pockets 44 may solely be disposed at an outer portion of the mattress 26 such that a middle portion of the mattress 26 may not include the plurality of air pockets 44.

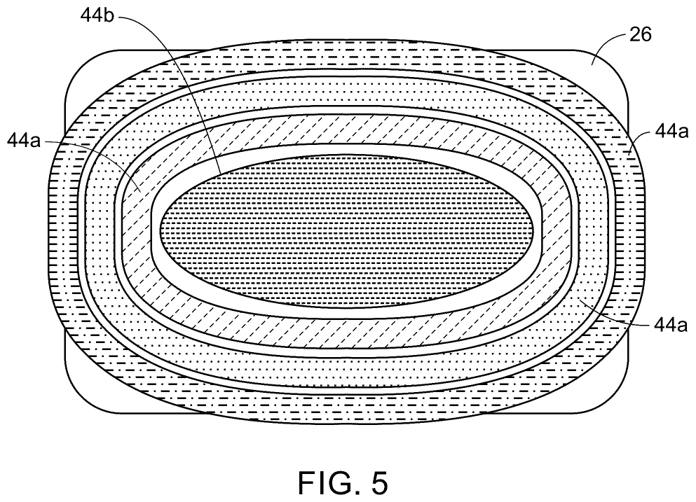

As shown in FIG. 5, the air pockets 44 may be arranged in an oval pattern. More specifically, the air pockets 44 may include a center oval air pockets 44b disposed at a center of mattress 26 with a plurality of ring air pockets 44a surrounding the center oval air pocket 44b. In some embodiments, the plurality of air pockets 44 may include three ring air pockets 44a. For example, a first ring air pockets 44a may surround the center oval air pocket 44b, a second ring air pockets 44a may surround the first ring air pocket 44a, and a third ring air pockets 44 may surround the second ring air pocket 44a. In other embodiments, the air pockets 44 may include more than or less than three ring air pockets 44a. Each of the ring air pockets 44 may include two side air pockets 44 and two end air pockets 44. In other words, each of the ring air pockets 44a may define four distinct air pockets 44. In other embodiments, the ring air pockets 44a may define one continuous air pocket 44.

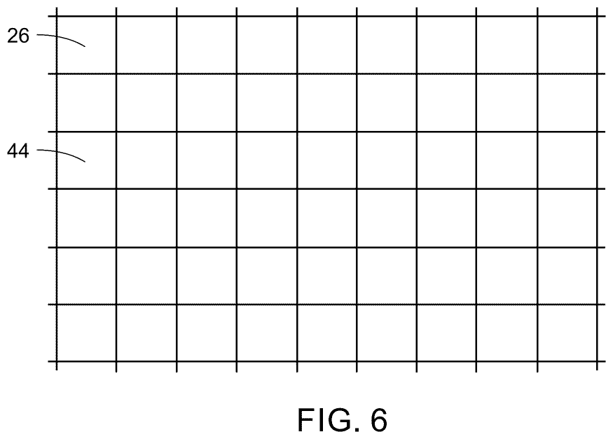

As shown in FIG. 6, in other embodiments, the plurality of air pockets 44 may be arranged in a grid, with each of the plurality of air pockets 44 being of equal size. In other embodiments, the plurality of air pockets 44 may define different sizes. The grid may be six air pockets 44 by nine air pockets 44, with 54 total air pockets 44. In other embodiments, the grid may define any number of air pockets 44. Each of the plurality of air pockets 44 may be a square air pocket 44. In other embodiments, the plurality of air pockets 44 may define a circle, oval, rectangle, or the like. In yet further embodiments, the plurality of air pockets 44 may include various shaped air pockets 44.

In other embodiments, the plurality of air pockets 44 may be arranged in any alternative pattern. For example, the air pockets 44 may be arranged in a square pattern, a circular pattern, or a random pattern. In some embodiments, the air pockets 44 may all be equal in size. In other embodiments, the air pockets 44 may have differing sizes.

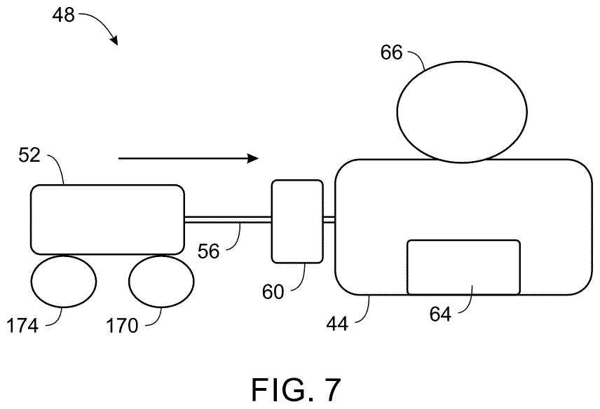

With reference to FIG. 7, in some embodiments, the air pockets 44 are fluidly distinct. In such embodiments, each of the air pockets 44 is coupled to a distinct pressure control unit 48. In other words, the infant care device 1 includes one pressure control unit 48 for every air pocket 44. The pressure control unit 48 may be supported by the infant care device 1. In other embodiments, the pressure control unit 48 may be supported and housed in a casing separate from the infant care device 1. The pressure control unit 48 regulates a gas inlet of the air pockets 44 to fill the air pockets 44 to a specific volume and/or pressure. The pressure control unit 48 includes an air pump 52, a conduit 56 coupled to the air pump 52 and the air pocket 44, and a flow sensor 60 disposed within the conduit 56. The air pump 52 is configured to push air into the air pockets 44 or remove air from the air pocket 44. The flow sensor 60 measures the rate of flow of the air moving through the conduit 56 and determines the volume of the air pocket 44. In use, the air pump 52 is actuated such that the air pump 52 supplies air to the air pocket 44 via the conduit 56. Once the flow sensor 60 determines that a desired volume of air has entered the air pocket 44, the air pump 52 is turned off.

In other embodiments, the air pockets 44 may be fluidly coupled. In such embodiments, the mattress 26 may solely include a singular pressure control unit 48 such that air travels from the pressure control units 48, to the air pockets 44 in the mattress 26. The air pockets 44 may include channels to fluidly couple adjacent air pockets 44. When air is traveling from the pressure control units 48, to the air pockets 44, the air may travel through the channels to fill all of the fluidly connected air pockets 44 in the mattress 26. The mattress 26 may further include strain gauges in the channels of the air pockets 44 to measure gas exchange between adjacent air pockets 44. Therefore, while each of the air pockets 44 is not independently pressurized, local pressure of the air pockets 44 may be determined via the strain gauge. In other embodiments, the mattress 26 may include a combination of fluidly distinct air pockets 44 and fluidly coupled air pockets 44. For example, the mattress 26 may include center air pockets 44 that are fluidly distinct and outer air pockets 44 that are fluidly coupled.

With continued reference to FIG. 7, the infant care device 1 further includes pressure sensors 64 disposed in each of the air pockets 44. The pressure sensor 64 senses a load 66 on the air pocket 44. For example, an arm of the baby may rest on the air pocket 44. The pressure sensor 64 within that particular air pockets 44 may measure the force exerted on the air pockets 44 by the arm supported by the air pocket 44. Therefore, each of the air pockets 44 measure the force exerted by the portion of the baby supported by the corresponding air pocket 44.

The pressure sensor 64 defines a load cell. Each of the load cells generates an electric signal based upon the amount of weight supported by the load cell. When the baby is on the mattress 26, the pressure sensors 64 in the air pockets 44 that are supporting the baby generate electric signals that are received by a control unit 150. Based on the received signals, the control unit 150 can determine where the baby is located on the top surface of the mattress 26. Specifically, the control unit 150 can interpret the electrical signals received from the plurality of load cells to determine which load cells are generating the largest electrical signal and thus are measuring the greatest amount of weight from the baby. By interpreting the electric signals from the plurality of load cells, the control unit 150 is able to identify which of the air pockets 44 are supporting a load and based on the sensed loads and determine the approximate location of the baby on the top surface of the mattress 26 and characteristics of the baby. More particularly, since the load cells are disposed within the air pockets 44, the control unit 150 can determine which of the air pockets 44 are supporting the baby.

In the embodiment shown in the drawing figures, the pressure sensors 64 are described and shown as being load cells that are positioned within the air pockets 44 and are connected to the control unit 150 such that the control unit 150 can detect and determine the location of the baby and characteristics of the baby. Although load cells are contemplated as being one exemplary embodiment, it is contemplated that other types of sensors could be utilized while operating within the scope of the present disclosure.

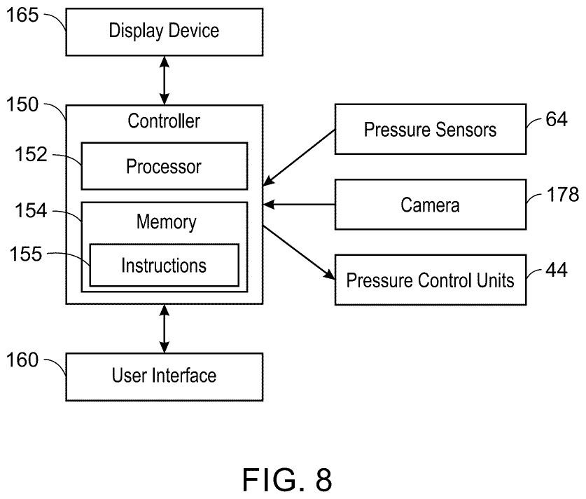

With reference to FIG. 8, the control unit 150 includes a processor 152 and a non-transitory memory 154. Methods for controlling the infant care device 1 may be stored as executable instructions 155 in the non-transitory memory 154 and executed by the processor 152.

The infant care device 1 further includes a user interface 160 for receiving input from a user or operator of the infant care device 1. The user interface 160 may be communicatively coupled to the control unit 150 for providing commands input by a user via the user interface 160 to the control unit 150. The user interface 160 may include one or more of a keyboard, a mouse, a trackball, one or more knobs, one or more joysticks, a touchpad, a touchscreen, one or more hard and/or soft buttons, a smartphone, a microphone, a virtual reality apparatus, and so on. The user interface 160 may thus enable voice control, and display of information such as an interactive display device (e.g., touchscreen). In some examples the user interface 160 may be remotely located relative to the infant care device 1. For example, the user interface 160 may be communicatively coupled to the control unit 150 and/or the infant care device 1 via a wired or wireless connection, and may be positioned away from the infant care device 1.

As an example, the memory 154 may store processor-executable software code or instructions (e.g., firmware or software), which are tangibly stored on a non-transitory computer readable medium. Additionally or alternatively, the memory 154 may store data. As an example, the memory 154 may include a volatile memory, such as random access memory (RAM), and/or a nonvolatile memory, such as read-only memory (ROM), flash memory, a hard drive, or any other suitable optical, magnetic, or solid-state storage medium, or a combination thereof. Furthermore, the processor 152 may include multiple microprocessors, one or more “general-purpose” microprocessors, one or more special-purpose microprocessors, and/or one or more application specific integrated circuits (ASICS), or some combination thereof. For example, the processor 152 may include one or more reduced instruction set (RISC) or complex instruction set (CISC) processors. The processor 152 may include multiple processors, and/or the memory 154 may include multiple memory devices.

### Prevent Baby Falls

As discussed above, the invention includes preventing the baby from falling off the mattress 26 when the baby is within the potential fall zone 40. More specifically, the control unit 150 retrieves a representation of the mattress 26 including the air pockets 44 from the memory 154. The memory 154 includes a representation of the air pockets 44 on the top surface of the mattress 26 and the locations that are defined as the safe baby zone 38 and the potential fall zone 40. The control unit 150 receives signals from the pressure sensors 64 within the air pockets 44. Based on the magnitude of the received signals, the control unit 150 can determine the location of the baby on the mattress 26 by referencing the mattress 26 having the air pockets 44 in the memory. Once the control unit 150 determines the general location of the baby on the mattress 26, the control unit 150 may additionally compare this location to the defined safe baby zone 38 and potential fall zone 40 to determine whether the baby is at risk of falling from the infant care device 1. In some embodiments, the control unit 150 may determine that the baby is shifting toward the potential fall zone 40, which may additionally present a risk of falling from the infant care device 1. During the initial setup of the infant care device 1, the control unit 150 can receive information about the location of the safe baby zone 38 and the potential fall zone 40 through an input device 48 or through an interactive display 50.

If the control unit 150 determines that the baby is within the potential fall zone 40, or shifting toward the potential fall zone 40, the control unit 150 can generate an alarm signal which can be shown on the user interface 160 or used to generate an alarm 52. The alarm 52 could be audible, visual or any other type of indicator that would alert the caregiver as to a potential unsafe condition. The alarm could also be a message sent to a caregiver, a nursing station or a remote location indicating that the baby is in an unsafe position and needs urgent attention from a caregiver.

In addition to generating an alarm 52, the control unit 150 can inflate the air pockets 44 within the potential fall zone 40 in order to create resistance to baby movement on the mattress 26. For example, the control unit 150 may inflate air pockets 44 positioned near the second side edge 36 of the mattress 26 and/or air pockets 44 positioned near the first side edge 34. If the center of gravity of the baby moves toward the second side edge 36, the air pockets 44 positioned near the second side edge 36 are inflated to restrict further baby movement. Likewise, if the center of gravity of the infant moves toward the first side edge 34, the air pockets 44 positioned near the first side edge 34 are inflated to restrict further baby movement. The air pockets 44 thus prevent further movement of the baby toward either the first side edge 34 or the second side edge 36 of the mattress 26. The control unit 150 may similarly inflate air pockets 44 near the ends of the mattress 26 to restrict baby movement near the ends of the mattress 26. When the body mass of the baby again moves back into the safe baby zone 38, air pockets 44 can be deflated to return to the initial condition shown in the drawing figures.

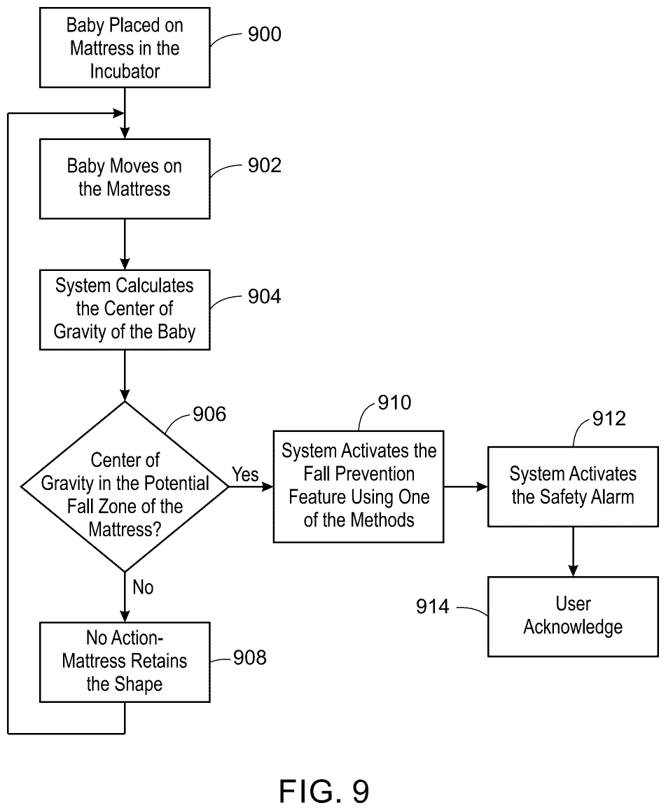

FIG. 9 illustrates an exemplary embodiment for a method of preventing a baby from falling from an infant care device 1 that includes a mattress 26 supported on a mattress tray 28. Initially, in step 900, a baby is placed on the mattress 26 within the infant care device 1. Initially, the baby is placed within the safe baby zone 38 by a caregiver. When the baby is supported on the mattress 26 within the infant care device 1, the control unit 150 shown in FIG. 8 monitors the electric signals from the plurality of pressure sensors 64. As previously described, the pressure sensors 64 can be load cells that are positioned within the air pockets 44, where each load cell generates an electric signal that is proportional to the amount of weight sensed by the individual load cell. Since the pressure sensors 64 are located in the air pockets 44, the magnitude of the signals transmitted from the pressure sensors 64 indicates the location of the baby on the mattress 26.

If the control unit 150 senses that the baby is moving on the mattress 26 based upon changing electrical signals from the pressure sensors 64, the system moves to step 902 where the control unit 150 obtains the electric signals from the pressure sensors 64.

Based upon the magnitude of the signals from the pressure sensors 64 and the location of the pressure sensors 64, the location of the baby and the baby's center of gravity can be determined in step 904. The location of the center of gravity of the baby is compared to the known outer margins of the combination of the mattress 26 and mattress tray 28. In step 906, the control unit 150 determines whether or not the center of gravity for the baby is within the potential fall zone 40 or whether the center of gravity is within the safe baby zone 38. If the center of gravity is not within the fall zone, the control unit 150 moves to step 908 and no action is taken and the mattress 26 retains its shape. The system then returns to step 902 where the control unit 150 again monitors for any additional movement of the baby on the mattress 26.

If the system determines in step 906 that the center of gravity of the baby is within the fall zone of the mattress 26, the system moves to step 910 where the control unit 150 inflates the air pockets 44 to provide restriction to the further movement of the baby on the mattress 26. In addition to inflating the air pockets 44, the control unit 150 activates a safety alarm in step 912. The safety alarm can be one of a variety of different alarm types, such as an audible alarm, a visual alarm, and indicator on a remote monitoring display or a message sent to a caregiver, or a combination of any one of these techniques.

The control unit 150 continues to activate the safety alarm and the air pockets 44 until the user acknowledges the alarm and moves the baby as illustrated in step 914. Once the baby has been moved and the alarm acknowledged, the system returns back to step 902 and monitors for additional movement of the baby on the mattress 26. In this manner, the control unit 150 is able to monitor the baby location on the mattress 26 and inflate the air pockets 44 to restrict additional baby movement while also alerting a caregiver as to the potentially dangerous location of the baby along the mattress 26.

In some embodiments, when the baby is moving toward the potential fall zone 40, the control unit 150 may inflate the air pockets 44 in order to move the baby away from the potential fall zone 40. The control unit 150 receives signals from the pressure sensors 64 indicating the location of the baby. When the baby begins moving, the magnitude of the signals transmitted by the pressure sensors 64 changes. For example, initially the baby may solely be in contact with a first air pockets 44 and, thus, a first sensor may solely transmit an initial signal to the control unit 150. When the baby moves, the baby may additionally be in contact with a second air pockets 44 and a third air pocket 44. Second and third pressure sensors 64 may additionally transmit signals to the control unit 150, with the signal transmitted by the first pressure sensor 64 being less than the initial signal due to the baby's weight being distributed. The change in transmitted signals indicates to the control unit 150 that the baby is moving. The control unit 150 may access the mattress 26 in the memory 154 to determine where the baby is moving. More specifically, the control unit 150 can compare the air pockets 44 having the pressure sensors 64 that are transmitting new signals with the mattress 26 in the memory 154. The mattress 26 in the memory 154 may show locations of the air pockets 44 in the mattress 26.

The control unit 150 may access the mattress 26 in the memory 154 to determine which of the air pockets 44 require inflation based on the position of the baby. The control unit 150 may additionally access patterns of inflating the air pockets 44 stored in the memory 154. The control unit 150 may match these patterns to the current position of the baby in order to determine how to inflate the air pockets 44 to move the baby away from the potential fall zone 40. For example, if the baby is moving their arm toward an outside air pocket 44, the control unit 150 can determine that the arm is on the outside air pockets 44 based on a received signal from an outside pressure sensor 64 disposed within the outside air pocket 44. The control unit 150 can access the patterns in the memory 154 to determine a height of the outside air pockets 44 required to move the arm back to a center air pocket 44. The control unit 150 may inflate the outside air pockets 44 to a predetermined height via the pressure control unit 48 to move the arm to the center air pocket 44. Once the arm is moved to the center air pocket 44, the control unit 150 may deflate the outside air pockets 44 via the pressure control units 48. In some embodiments, the caregiver may manually choose which air pockets 44 to inflate via the user interface 160. When the baby is moving toward the potential fall zone 40, the control unit 150 may or may not actuate the alarm. Whether the control unit 150 actuates the alarm may be based on how close the baby is to the potential fall zone 40.

In some embodiments, the control unit 150 may inflate the air pockets 44 each time the baby moves in order to keep the baby in the safe baby zone 38. In other embodiments, the control unit 150 may inflate the air pockets 44 only when the baby is at a particular distance from the potential fall zone 40 or is within the potential fall zone 40.

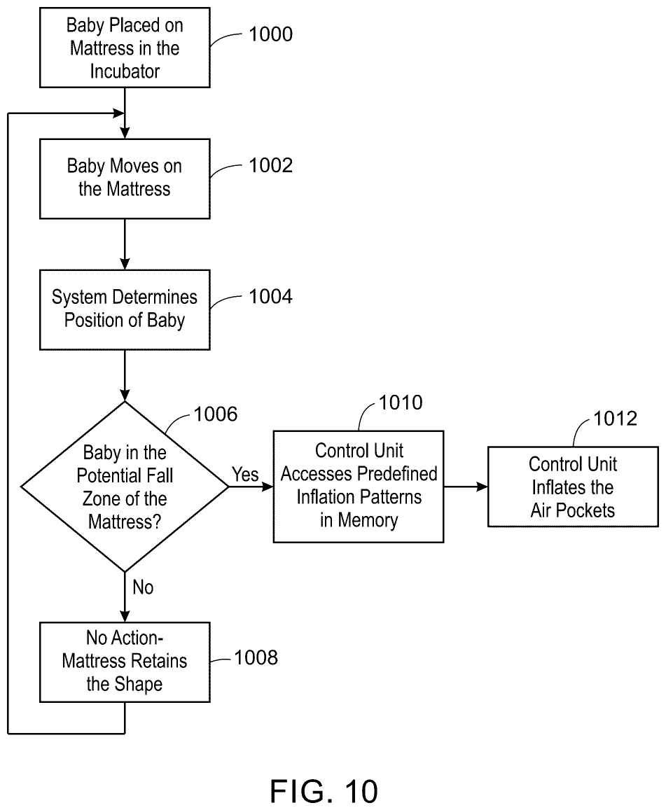

FIG. 10 illustrates another exemplary embodiment for a method of preventing a baby from falling from an infant care device 1 that includes a mattress 26 supported on a mattress tray 28. Initially, in Step 1000 baby is placed on the mattress 26 within the infant care device 1. Initially, the baby is placed within the safe baby zone 38 by a caregiver. When the baby is supported on the mattress 26 within the infant care device 1, the control unit 150 shown in FIG. 8 monitors the electric signals from the plurality of pressure sensors 64. If the control unit 150 senses that the baby is moving on the mattress 26 based upon changing electrical signals from the pressure sensors 64, the control unit 150 obtains the electric signals from the pressure sensors 64 as illustrated in Step 1002.

Based upon the magnitude of the signals from the pressure sensors 64, the control unit 150 determines the location of the baby as illustrated in Step 1004. The control unit 150 determines if the baby is moving toward the potential fall zone 40 as illustrated in Step 1006. If the control unit 150 determines that the baby is not shifting toward the potential fall zone 40, the control unit 150 moves to step 1008 and no action is taken and the mattress 26 retains its shape. The system then returns to step 1002 where the control unit 150 again monitors for any additional movement of the baby on the mattress 26.

If the system determines that the baby is moving toward the fall zone, the system moves to step 1010 where the control unit 150 accesses the mattress 26 in the memory 154 to determine which of the air pockets 44 require inflation based on the position of the baby and predefined patterns of inflation stored in the memory 154. In other words, the memory 154 includes patterns of inflating the air pockets 44 in order to move the baby in a desired manner. These patterns are matched with the current position of the baby in order to move the baby away from the potential fall zone 40. The control unit 150 inflates the air pockets 44 based on the determined predefined pattern of inflation as illustrated in Step 1012. In this manner, the control unit 150 is able to monitor the baby location on the mattress 26 and inflate the air pockets 44 to move the baby away from the potential fall zone 40.

### Sleep Apnea

The mattress 26, and specifically the control unit 150, may be configured to track whether the baby is breathing properly while sleeping and stimulate the baby if a lapse of breathing occurs. As discussed above, the pressure sensors 64 may detect movement of the baby. When the baby is sleeping, the pressure sensors 64 may detect changes in pressure occurring due to the baby breathing. The control unit 150 may determine that a baby is sleeping based on a frequency of small pressure changes. The memory 154 may include stored rhythmic patterns that indicate the baby is sleeping. The control unit 150 may reference the stored rhythmic patterns to determine whether the baby is sleeping. Once the control unit 150 determines that the baby is sleeping, the control unit 150 may record an elapsed time between each pressure change, or breath. If the elapsed time is below a predetermined threshold, the control unit 150 continues to record the elapsed times. If the elapsed time is above a predetermined threshold, the control unit 150 determines that the baby is not breathing, and a sleep apnea event is occurring. When the sleep apnea event occurs, the control unit 150 can generate an alarm signal which can be shown on the user interface 160 or used to generate an alarm 52. The alarm 52 could be audible, visual or any other type of indicator that would alert the caregiver as to a potential unsafe condition. The alarm could also be a message sent to a caregiver, a nursing station or a remote location indicating that the baby is not breathing and needs urgent attention from a caregiver. In some embodiments, the control unit 150 may additionally stimulate the baby by increasing and decreasing the pressure in the air pockets 44 to simulate a rocker. Additionally or alternatively, the control unit 150 may stimulate the baby by suddenly increasing and decreasing the pressure in the air pockets 44 to simulate a jerk.

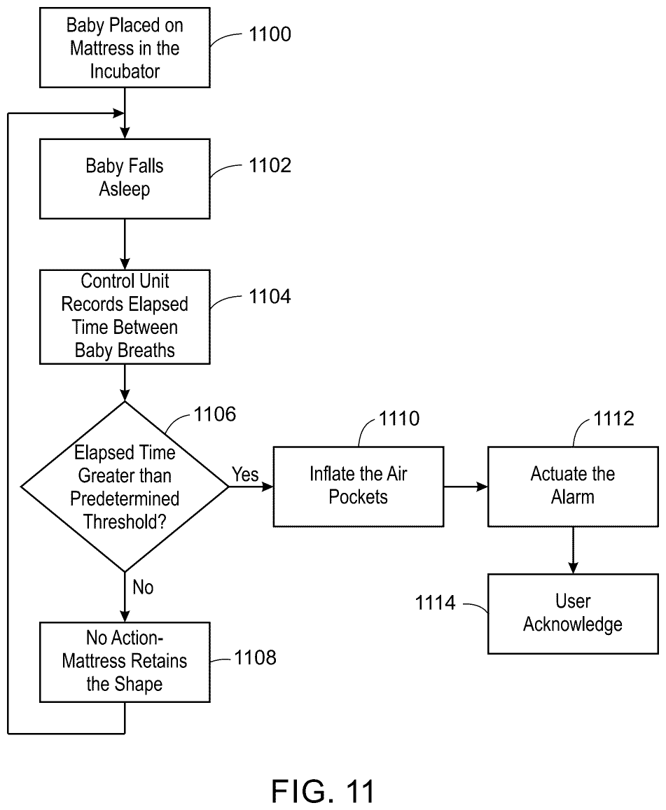

FIG. 11 illustrates an exemplary embodiment for a method of detecting that a baby is breathing properly while sleeping and stimulating the baby if a lapse of breathing occurs to promote breathing. Initially, in step 1100, a baby is placed on the mattress 26 within the infant care device 1. When the baby falls asleep, the control unit 150 determines that the baby is sleeping as illustrated at Step 1102. The control unit 150 records the elapsed time between each breath of the baby as illustrated at Step 1104. The control unit 150 then moves to Step 1106 to determine if the elapsed time is greater than the predetermined threshold. If the elapsed time is below the predetermined threshold, the control unit 150 continues recording the time between breaths and no action is taken as illustrated at Step 1108. If the elapsed time is above the predetermined threshold, the control unit 150 determines that the sleep apnea event is occurring. The control unit 150 inflates and deflates the air pockets 44 to stimulate the baby as illustrated at Step 1110. The control unit 150 additionally actuates the alarm to indicate that the sleep apnea event is occurring as illustrated at Step 1112. The control unit 150 additionally inflates and deflates the air pockets 44 to stimulate the baby. The control unit 150 continues to activate the safety alarm and the air pockets 44 until the user acknowledges the alarm and moves the baby as illustrated at Step 1114. Once the baby has been moved and the alarm acknowledged, the system returns back to step 1102 and monitors for another sleep apnea event of the baby on the mattress 26. In this manner, the control unit 150 is able to monitor the baby's breathing while the baby is sleep on the mattress 26 and inflating the air pockets 44 to stimulate breathing while also alerting a caregiver as to the baby having a sleep apnea event.

In some embodiments, the control unit 150 may track the sleep apnea events as they occur. For example, the control unit 150 may count each time the sleep apnea event occurs in a given time frame via a counter. If the counter surpasses a predetermined threshold, the control unit 150 may actuate an alarm to alert the caregiver that the baby has experienced the predetermined threshold of the sleep apnea events. The control unit 150 may store characteristics of each of the sleep apnea events and create a trend based on the stored characteristics. For example, the control unit 150 may store a length of each sleep apnea event, a time between sleep apnea event, and similar characteristics about the sleep apnea event. The control unit 150 may provide a risk score to the caregiver based on the counted sleep apnea events and/or the stored characteristics. The risk score may indicate how likely the baby is at risk of having additional sleep apnea events.

### Chest Compressions

The mattress 26, and specifically the control unit 150, may be configured to track whether chest compressions are being performed correctly. As discussed above, the pressure sensors 64 may detect movement of the baby. When chest compressions are being performed on the baby, the pressure sensors 64 may detect the impulses of the chest compressions and the forces of the chest compressions. In other words, the pressure sensors 64 detect the impulse and force being imparted onto the baby by the caregiver during a chest compression. Additionally, the control unit 150 may determine the frequency of the chest compressions based on the frequency of the received signals from the pressure sensors 64. The memory 154 includes ideal stored chest compressions. The ideal stored chest compressions are based on the baby's weight and/or volume, which may additionally be measured by the mattress 26 as explained below. The ideal stored chest compressions include an ideal impulse of press, an ideal force of press, and an ideal speed of release of press. The ideal stored chest compressions may include additionally parameters not expressly stated. The control unit 150 compares the sensed chest compressions with the ideal stored chest compressions. For example, the control unit 150 may instruct the caregiver to increase the frequency of the chest compressions or impart less force during the chest compression. The control unit 150 displays on the user interface 160 how the caregiver can improve the chest compressions. In other words, the control unit 150 provides feedback to the caregiver to improve the caregiver's chest compressions while the caregiver is giving chest compressions.

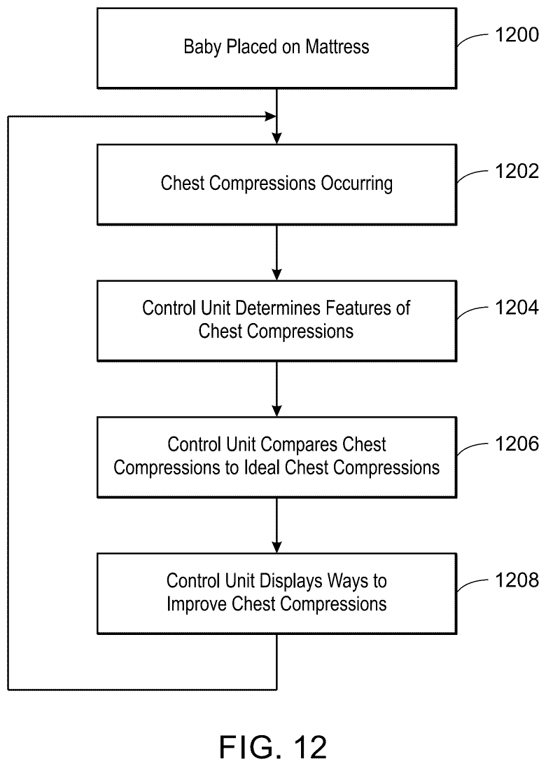

FIG. 12 illustrates an exemplary embodiment for a method of detecting whether chest compressions are being performed correctly and provide feedback to the caregiver. Initially, in step 1200, a baby is placed on the mattress 26 within the infant care device 1. The control unit 150 determines that chest compressions are being performed on the baby based on the signals received from the pressure sensors 64 as illustrated at Step 1202. The control unit 150 determines the impulse of the chest compressions, the force of the chest compressions, and the frequency of the chest compressions based on the signals received from the pressure sensors 64 as illustrated at Step 1204. The control unit 150 compares the chest compressions with the ideal stored chest compressions as illustrated at Step 1206. The control unit 150 displays on the user interface 160 ways for the caregiver to improve the chest compressions as illustrated at Step 1208. The control unit 150 moves to Step 1202 where the control unit 150 continues to compare the chest compressions to the ideal stored chest compressions while the caregiver is giving chest compressions. Therefore, the control unit 150 provides active feedback on the chest compressions to the caregiver.

### Calibration

The invention contemplates an auto calibration feature. Scales may have drift which impacts the accuracy of the weight measured by the scale. For example, a scale may initially measure a 2 kg body as 2 kg, however, over time the scale may measure the 2 kg body as 2.2 kg. Therefore, the caregiver must calibrate the scale to ensure that the scale provides an accurate reading. Typically, the caregiver must remove the baby from the mattress 26 in order for the system to calibrate. The invention provides an auto calibration feature which allows the infant care device 1 to calibrate without the removal of the baby from the mattress 26. The infant care device 1 is calibrated to determine if drift has occurred, and if drift has occurred, account for the drift.

The control unit 150 uses a two-point calibration to calibrate the pressure sensor 64. The two-point calibration includes positioning the baby on the mattress 26. The pressure sensor 64 measures an initial pressure within the air pocket 44. The pressure control unit 48 pushes air into the air pocket 44, increasing the volume within the air pocket 44. The flow sensor 60 measures the change in volume V1. The control unit 150 determines a change in pressure P1 within the air pockets 44 based on known mathematical equation (e.g., PV=nRT). The change in volume V1 is correlated with the change in pressure P1. This process is repeated once more to determine a second change in volume V2 and a second change in pressure P2. The second change in volume V2 is corelated with the second change in pressure P2. The control unit 150 creates a linear relationship between the two correlations in order to calibrate the pressure sensor 64. The control unit 150 may perform the two-point calibration at set increments that may be determined by the caregiver. For example, the two-point calibration may occur every day, every week, or any other incremental period. Additionally or alternatively, the caregiver may choose when to perform the two-point calibration via actuating the user interface 160.

### Various Features

As discussed above, the mattress 26 may be configured to position the baby in various positions via the air pockets 44 for procedures, treatments, feedings, and the like. The memory 154 of the control system may include various inflation patterns for various procedures. The inflation patterns may include heights for each of the air pockets 44 and/or pressures required for each of the air pockets 44. In some embodiments, the caregiver may manually input an inflation pattern via the user interface 160. The caregiver may choose an inflation pattern via the user interface 160. When the inflation pattern is chosen, the control unit 150 inflates the air pockets 44 via the pressure control units 48 based on the inflation pattern. Once the air pockets 44 are inflated, the baby is in the preferred position for the procedure. Once the procedure is completed, the caregiver may choose a neutral bed position on the user interface 160. The control unit 150 may adjust the air pressure in the air pockets 44 such that the baby is in a neutral laying position. For example, if the caregiver is preparing to feed the baby, the ideal position may be an upright cradled position. The caregiver may choose an inflation pattern on the user interface 160 designated for a feeding. Once the caregiver chooses the inflation pattern, the control unit 150 inflates the air pockets 44 various amounts such that the baby is in an upright cradled position. Once the caregiver has completed the feeding, the caregiver may choose a neutral bed position via the user interface 160. The control system may adjust the inflation of the air pockets 44 such that the baby is moved to a laying position.

The mattress 26 may additionally be configured to adjust the firmness of the mattress 26 via changing the air pressure in the air pockets 44. Specifically, the caregiver may choose a desired firmness level on the user interface 160. The desired firmness level may include air pressures required for each of the air pockets 44 in order to actualize the desired firmness level. Once the firmness level is chosen, the control unit 150 adjusts the pressure within the air pockets 44 via the pressure control units 48. The caregiver may additionally choose different firmness levels for different sections of the mattress 26 via the user interface 160. The control unit 150 adjusts the air pressure in each of the air pockets 44 via the pressure control units 48 in order to accommodate the desired firmness levels. Changing the firmness level allows the caregiver to adjust the firmness of the mattress 26 for a particular procedure. For example, if the baby requires chest compressions, a firm mattress is desired.

The mattress 26 may additionally be configured to determine a weight of the baby disposed on the mattress 26. When the baby is laying on the mattress 26, the pressure sensors 64 within the air pockets 44 transmit signals to the control unit 150. Based on the received signals, the control unit 150 can determine the total pressure sensed on the mattress 26. The total pressure can be used with the sensed area of the baby to calculate the weight of the baby via known mathematical equations (e.g., P=W/A). Therefore, the caregiver may determine the weight of the baby without removing the baby from the mattress 26.

The mattress 26 may additionally be configured to adjust a temperature of the mattress 26 to control a temperature of the baby. Specifically, the pressure control units 48 may additionally include condensers 170 configured to cool air and/or heaters 174 to heat air. The user interface 160 may include a temperature adjustment that allows the caregiver to adjust the temperature of the mattress 26. When the temperature of the mattress 26 is adjusted to a lower temperature via the user interface 160, the condenser 170 cools the air that is provided to the air pump 52 to a desired air temperature. The air pump 52 pumps the cooled air into the air pocket 44, cooling the mattress 26. When the temperature of the mattress 26 is adjusted to a higher temperature via the user interface 160, the heater 174 heats the air that is provided to the air pump 52 to a desired air temperature. The air pump 52 pumps the heated air into the air pocket 44, heating the mattress 26. The mattress 26 may allow the caregiver to choose particular air pockets 44 to heat and/or cool via the user interface 160. In such embodiments, once the caregiver chooses the air pockets 44 that will be heated or cooled, solely the pressure control units 48 associated with the chosen air pockets 44 are heated or cooled. Heating or cooling only a portion of the mattress 26 allows for certain body parts on the baby to be heated and/or cooled.

In some embodiments, the infant care device 1 may additionally include a camera 178 that is electrically connected to the control unit 150 (shown in FIGS. 1 and 2). The camera 178 may be coupled to a portion of the infant care device 1. In other embodiments, the camera 178 may be separate from the infant care device 1. The camera 178 may be directed toward the baby. The camera 178 may be configured to detect a location of the baby on the mattress 26 and transmit that information to the control unit 150. The camera 178 may use known image recognition software to recognize the baby. In some embodiments, the camera 178 may detect which air pockets 44 are supporting the baby. The camera 178 may additionally be configured to detect a general size of the baby. For example, the camera 178 may detect an outline of the baby on the mattress 26. The camera 178 may transmit the outline to the control unit 150. The control unit 150 may determine a size of the baby based on the transmitted outline and information stored in the memory 154.

The camera 178 may additionally detect foreign bodies on the mattress 26. For example, the camera 178 may determine that a foreign body is additionally located on the mattress 26. The foreign body may be a blanket, tube, or a similar device. The camera 178 uses known image recognition software to recognize the foreign body. The camera 178 may transmit this information to the control unit 150. The control unit 150 may disregard pressure readings of the pressure sensors 64 within the air pockets 44 that are supporting the foreign body based on the information received from the camera 178. The camera 178 may additionally be configured to include additionally functionality not expressly stated.

As discussed above, the inventors have also recognized the need for a system that reduces the number of interactions required between a caregiver and a baby. Specifically, the baby may require repositioning by the caregiver to accommodate for procedures, treatments, feedings, and the like. The caregiver additionally measures characteristics of the baby, such as weight of the baby. Each time the caregiver interacts with the baby, the baby is exposed to the environment external of the incubator. This exposure can introduce risks such as temperature fluctuations, potential infections, and other environmental hazards.

Accordingly, the inventors have developed a multi pocket pressure-controlled mattress 26 that measures a weight of a baby and a location and/or position of a baby via pressure sensors 64. The pockets of the mattress 26 can be height adjusted locally using pressure pumps in order to change the location of the baby to prevent the baby from falling off of the mattress 26. The mattress 26 may additionally position the baby for procedures, treatments, feeding, and the like. Measuring the pressure sensors 64 may additionally be used to measure characteristics of the baby, such as the weight of the baby, the breathing pattern of the baby, and other characteristics.

This written description uses examples to disclose the invention, including the best mode, and also to enable any person skilled in the art to make and use the invention. Certain terms have been used for brevity, clarity and understanding. No unnecessary limitations are to be inferred therefrom beyond the requirement of the prior art because such terms are used for descriptive purposes only and are intended to be broadly construed. The patentable scope of the invention is defined by the claims, and may include other examples that occur to those skilled in the art. Such other examples are intended to be within the scope of the claims if they have features or structural elements that do not differ from the literal language of the claims, or if they include equivalent features or structural elements with insubstantial differences from the literal languages of the claims.

We claim:

1. An infant care device for use with a baby, comprising:
a mattress configured to support the baby within the infant care device;
air pockets forming a top surface of the mattress; and
pressure sensors disposed within each of the air pockets, the pressure sensors being configured to sense a location of the baby on the mattress;
wherein air pressures of the air pockets are individually adjusted based on the sensed location of the baby.

2. The infant care device of claim 1, wherein the air pockets are fluidly distinct.

3. The infant care device of claim 2, further comprising pressure control units fluidly coupled to the air pockets, the pressure control units supplying air to the air pockets to adjust the air pressures of the air pockets.

4. The infant care device of claim 3, wherein the pressure control units each include an air pump, a conduit connecting the air pump to the air pocket, and a flow sensor disposed within the conduit.

5. The infant care device of claim 1, wherein the air pockets are fluidly connected.

6. The infant care device of claim 5, wherein strain gauges are disposed in the air pockets to determine a fluid exchange between the air pockets.

7. The infant care device of claim 1, wherein the air pockets are arranged in an oval pattern with a center oval air pocket surrounded by a ring air pocket.

8. The infant care device of claim 1, wherein the air pockets are arranged in a grid pattern.

9. The infant care device of claim 1, further comprising a control unit electrically connected to the pressure sensors, and wherein the control unit determines which air pockets are supporting the baby based on a magnitude of signals received from the pressure sensors.

10. An infant care device for use with a baby, comprising:
a mattress configured to support the baby within the infant care device;
air pockets forming a top surface of the mattress; and
a control unit including a stored inflation pattern for individually adjusting air pressures of the air pockets;
wherein inflating the air pockets based on the inflation pattern moves the baby from a first position to a second position.

11. The infant care device of claim 10, further comprising pressure sensors disposed within each of the air pockets, the pressure sensors being electrically connected to the control unit.

12. The infant care device of claim 11, wherein the control unit determines which air pockets are supporting the baby based on a magnitude of signals received from the pressure sensors.

13. The infant care device of claim 12, wherein the control unit measures a weight of the baby based on the signals receive from the pressure sensors.

14. The infant care device of claim 13, wherein the control unit calibrates the pressure sensors without removal of the baby from the mattress.

15. The infant care device of claim 10, wherein the control unit may change a temperature of the mattress by changing a temperature of air used to adjust the air pressures of the air pockets.

16. The infant care device of claim 10, further comprising a camera that is electrically connected to the control unit, and wherein the camera detects a location of the baby on the mattress and transmits the location to the control unit.

17. The infant care device of claim 10, further comprising pressure control units fluidly coupled to the air pockets, the pressure control units supplying air to the air pockets to inflate the air pockets.

18. A method of preventing a baby from falling from an infant care device including a mattress, comprising:
positioning pressure sensors within air pockets on the mattress;
determining the baby is moving toward an edge of the mattress based on information received from the pressure sensors; and
individually inflating the air pockets to move the baby away from the edge of the mattress.

19. The method of claim 18, further comprising receiving signals from the pressure sensors, the signals having different magnitudes.

20. The method of claim 19, further comprising retrieving a predefined inflation pattern from a memory to inflate the air pockets.
